(19) United States
(12) Patent Application Publication
(10) Pub. No.: US 2025/0137239 A1
(43) Pub. Date: May 1, 2025

(54) WATER MANAGEMENT

(71) Applicant: Ademco Inc., Golden Valley, MN (US)

(72) Inventors: Jonathan Kuczwaj, Danbury, CT (US); James Woolaway, Carbondale, CO (US)

(73) Assignee: Ademco Inc., Golden Valley, MN (US)

(21) Appl. No.: 18/834,823

(22) PCT Filed: Jan. 25, 2023
(86) PCT No.: PCT/US2023/061225

§ 371 Date: Jul. 31, 2024

Related U.S. Application Data
(60) Provisional application No. 63/305,487, filed on Feb. 1, 2022.

(51) Int. Cl. E03B 7/07; A01G 25/16; E03B 7/04

(52) U.S. Cl. CPC E03B 7/07; A01G 25/16; E03B 7/04

(57) ABSTRACT

A water management system (100) includes a water management controller (112) at a premises (105) and first and second water meters (130, 135) in communication with the controller (112). The first water meter (130) is positioned at a water ingress line (131) of the premises (105) and configured to measure an amount of water supplied to the premises (105) via the water ingress line (131). The second water meter (135) is positioned at a first water egress line (136) of the premises (105) and configured to measure an amount of water supplied from the premises (105) to a first exterior water consuming object (141) via the first water egress line (136). The controller (112) is configured to determine an amount of water used within the premises (105) using at least (i) the measured amount of water supplied to the premises (105) via the water ingress line (131), and (ii) the measured amount of water supplied from the premises (105) to the first exterior water consuming object (141) via the first water egress line (136).

### RELATED APPLICATIONS

This application claims priority to U.S. Provisional Application No. 63/305,487, filed Feb. 1, 2022, the entire contents of which are incorporated herein by reference.

### TECHNICAL FIELD

This disclosure relates generally to water management. For example, embodiments disclosed herein include measuring premises water usage to inform premises water usage insights and management (e.g., control).

### BACKGROUND

A typical premises water system has a municipal water meter outside the premises at a municipal water inlet line to the premises. Such a municipal water meter can be inconvenient to access and, when accessed, difficult to read. Moreover, the municipal water meter generally is only able to provide total premises water use over relatively long-term periods of time. This makes it difficult to discern, and manage, specific subsets of water use at the premises. As a result, water use inefficiencies (e.g., leaks) and water overuse can go undetected and, even if detected, total premises water use as measured by the municipal water meter can be too general in nature to allow for readily addressing and managing subsets of water use at the premises that are inefficient.

### SUMMARY

This disclosure in general describes premises water management devices, systems, and methods. In particular, embodiments disclosed herein can facilitate beneficial premises water usage insights and control features for managing premises water usage. Such embodiments can provide premises water usage management via specific insights as to one or more subsets of water use at the premises and, thereby, can allow a user to manage premises water use in a precise, tailored manner that efficiently addresses particular, targeted subsets of premises water use in a timely manner. Certain such embodiments disclosed herein can allow a user to manage premises water use by inputting data as to premises water use targets for a predetermined period of time and these embodiments can provide one or more insights as to projected premises water use (e.g., over that predetermined period of time for which the target usage was set), including. for example, providing insights as to relatively high use areas for particular subsets of premises water use.

These embodiments can utilize one or more water meters positioned at strategic locations and leverage the data collected by such one or more water meters to derive the particular premises water usage insights. In some further such embodiments, an irrigation controller component and/or one or more water quality sensor components can be utilized to enable further control and management of particular subsets of premises water use and/or to provide insights as to water characteristics (e.g., water quality metrics) for informing decisions as to future water use. As one specific example, such embodiments disclosed herein can be useful in detecting leaks at a premises water line that otherwise, in a typical total premises water use only system, would be difficult to detect and, even if detected, difficult to find and address.

One embodiment includes a water management system. This water management system embodiment includes a water management controller at a premises, a first water meter, and a second water meter. The first water meter is positioned at a water ingress line of the premises, and the first water meter is in communication with the water management controller. The first water meter is configured to measure an amount of water supplied to the premises via the water ingress line. The second water meter is positioned at a first water egress line of the premises, and the second water meter is in communication with the water management controller. The second water meter is configured to measure an amount of water supplied from the premises to a first exterior water consuming object via the first water egress line. The water management controller is configured to determine an amount of water used within the premises using at least (i) the measured amount of water supplied to the premises via the water ingress line, and (ii) the measured amount of water supplied from the premises to the first exterior water consuming object via the first water egress line.

In a further embodiment of this system, the system further includes a third water meter positioned at a second water egress line of the premises. The third water meter is in communication with the water management controller, and the third water meter is configured to measure an amount of water supplied from the premises to a second exterior water consuming object via the second water egress line. And, the water management controller is further configured to determine the amount of water used within the premises using at least (i) the measured amount of water supplied to the premises via the water ingress line, (ii) the measured amount of water supplied from the premises to the first exterior water consuming object via the first water egress line, and (iii) the measured amount of water supplied from the premises to the second exterior water consuming object via the second water egress line.

In a further embodiment of this system, the first exterior water consuming object is an exterior irrigation system. This exterior irrigation system can include an irrigation controller in communication with the water management controller, a first irrigation zone, and a second irrigation zone. The first irrigation zones includes a first irrigation zone water supply line that is connected to the first water egress line of the premises and a first irrigation zone valve that is connected to the first irrigation zone water supply line, and the first irrigation zone valve is in communication with the irrigation controller. The second irrigation zone includes a second irrigation zone water supply line that is connected to the first water egress line of the premises and a second irrigation zone valve that is connected to the second irrigation zone water supply line, and the second irrigation zone valve is in communication with the irrigation controller.

In some cases, the exterior irrigation system can further include the second water meter. The irrigation controller can be configured to execute a first irrigation zone irrigation cycle by actuating the first irrigation zone valve to cause water to be supplied from the first water egress line of the premises and output via one or more water output devices at the first irrigation zone water supply line, and the irrigation controller can be configured to execute a second irrigation zone irrigation cycle by actuating the second irrigation zone valve to cause water to be supplied from the first water egress line of the premises and output via one or more water output devices at the second irrigation zone water supply line. The water management controller can be configured to determine an amount of water used by the first irrigation zone irrigation cycle using at least the measured amount of water supplied from the premises to the exterior irrigation system via the first water egress line during the first irrigation zone irrigation cycle, and the water management controller can be configured to determine an amount of water used by the second irrigation zone irrigation cycle using at least the measured amount of water supplied from the premises to the exterior irrigation system via the first water egress line during the second irrigation zone irrigation cycle. At least one of the irrigation controller and the water management controller can be configured to execute a first irrigation zone calibration by actuating the first irrigation zone valve to cause water to be supplied from the first water egress line of the premises and output via one or more water output devices at the first irrigation zone water supply line for a first calibration period of time, and, similarly, at least one of the irrigation controller and the water management controller can be configured to determine an amount of water used by the first irrigation zone calibration using at least the measured amount of water supplied from the premises to the exterior irrigation system via the first water egress line during the first calibration period of time. In addition, in some such cases, at least one of the irrigation controller and the water management controller can be further configured to compare the determined amount of water used by the first irrigation zone calibration during the first calibration period of time to the determined amount of water used by the first irrigation zone irrigation cycle during the first irrigation zone irrigation cycle. And, when at least one of the irrigation controller and the water management controller determines that the determined amount of water used by the first irrigation zone calibration during the first calibration period of time differs from the determined amount of water used by the first irrigation zone irrigation cycle during the first irrigation zone irrigation cycle by a predetermined threshold, at least one of the irrigation controller and the water management controller can generate an irrigation system water leak alert.

In those such noted system embodiments where the first exterior water consuming object is an exterior irrigation system, the irrigation controller can include a rain delay input. The water management system controller can be configured to use the determined amount of water used within the premises to cause a reduction in the amount of water supplied from the premises to the exterior irrigation system, and the water management controller can be configured to transmit a water use reduction command to the rain delay input of the irrigation controller. This can be useful in facilitating compatibility between the water management system controller and the irrigation controller (e.g., facilitating compatibility for receiving one or more control signals output from the water management system controller at the irrigation controller).

In a further embodiment of this system, the system can also include a water quality sensor at the water ingress line of the premises. The water quality sensor can be in communication with the water management controller, and the water quality sensor can be configured to measure at least one water quality metric of water supplied to the premises via the water ingress line. For instance, the water quality sensor can be configured to measure a first type of water quality metric of water supplied to the premises via the water ingress line at a first time and communicate the first type of water quality metric measured at the first time to the water management controller, and the water quality sensor can be configured to measure the first type of water quality metric of water supplied to the premises via the water ingress line at a second time that is different than the first time and communicate the first type of water quality metric measured at the second time to the water management controller. The water management controller can be configured to compare the first type of water quality metric measured at the first time to the first type of water quality metric measured at the second time, and the water management controller can further be configured to generate a water quality change alert when the first type of water quality metric measured at the first time differs from the first type of water quality metric measured at the second time by a predetermined threshold.

In a further embodiment of this system, the water management system controller can be configured to estimate an amount of water to be used within the premises over a future preset period of time using at least the determined amount of water used within the premises over a preceding period of time. For example, the water management controller can be configured to generate a premises projected water overuse alert when the estimated amount of water to be used within the premises over the future preset period of time exceeds a preset premises target water usage amount for the future preset period of time. As a further example, when the estimated amount of water to be used within the premises over the future preset period of time exceeds a preset premises target water usage amount for the future preset period of time, the water management controller can be configured to cause a reduction in the amount of water supplied from the premises to the first exterior water consuming object via the first water egress line. In one particular such example case, the first exterior water consuming object can be an exterior irrigation system, and the water management controller can be configured to cause the reduction in the amount of water supplied from the premises to the exterior irrigation system by causing an irrigation cycle of the exterior irrigation system to be skipped.

Another embodiment includes a water management controller. This water management controller can include a non-transitory computer-readable storage article including computer-executable instructions, and programmable processing circuitry that is configured to execute the computer-executable instructions. When so executed, the computer-executable instructions can cause the programmable processing circuitry to: receive, from a first water meter positioned at a water ingress line of a premises, a measured amount of water supplied to the premises via the water ingress line, receive, from a second water meter positioned at a first water egress line of the premises, a measured amount of water supplied from the premises to a first exterior water consuming object via the first water egress line, and determine an amount of water used within the premises using at least (i) the measured amount of water supplied to the premises via the water ingress line, and (ii) the measured amount of water supplied from the premises to the first exterior water consuming object via the first water egress line.

In a further embodiment of this water management controller, the computer-executable instructions can be further configured to cause the programmable processing circuitry to: estimate an amount of water to be used within the premises over a future preset period of time using at least the determined amount of water used within the premises over a preceding period of time, and, when the estimated amount of water to be used within the premises over the future preset period of time exceeds a preset premises target water usage amount for the future preset period of time, cause a reduction in the amount of water supplied from the premises to the first exterior water consuming object.

An additional embodiment includes a method. This method embodiment includes the steps of: receiving, at a water management controller, an amount of water, as measured by a first water meter positioned at a water ingress line of a premises, supplied to the premises via the water ingress, receiving, at the water management controller, an amount of water, as measured by a second water meter positioned at a first water egress line of the premises, supplied from the premises to a first exterior water consuming object via the first water egress line, and determining an amount of water used within the premises using at least (i) the amount of water supplied to the premises via the water ingress line, and (ii) the amount of water supplied from the premises to the first exterior water consuming object via the first water egress line.

In a further embodiment of this method, the method can also include the steps of: estimating, at the water management controller, an amount of water to be used within the premises over a future preset period of time using at least the determined amount of water used within the premises over a preceding period of time, and, when the estimated amount of water to be used within the premises over the future preset period of time exceeds a preset premises target water usage amount for the future preset period of time, causing, via the water management controller, a reduction in the amount of water supplied from the premises to the first exterior water consuming object.

In some cases, certain of those embodiments noted above can obtain and utilize exterior premises data (e.g., exterior irrigation data, exterior pool data, soil data, etc.). In certain of these cases, the exterior premises data can be obtained and utilized in combination with one or more other premises data points, such as in combination with one or more interior premises data points. For instance, the present disclosure describes various embodiments, including some embodiments that provide an integrated system which can include an exterior premises sensor (e.g., exterior irrigation system sensor, exterior pool sensor, soil sensor) and an interior premises sensor each in signal communication with a premises water management controller, which itself can be in further signal communication with one or more premises water exterior water consuming objects, a remote server, and/or a remote user device. Some useful advantages of certain such embodiments of the present disclosure include facilitating exterior premises water usage management and control that is informed by one or more interior premises data points. This can allow the premises water management controller to take control actions related to the one or more exterior water consuming objects based on one or more interior premises data points (e.g., interior premises water use, premises water quality, interior premises occupancy, interior premises daylight irradiance, interior premises security data, interior premises temperature, interior premises energy use, interior premise application energy and/or water use, etc.).

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a block diagram of an embodiment of a water management system.

FIG. 2 is a flow diagram of an embodiment of a method for determining water used within a premises.

FIG. 3 is a flow diagram of an embodiment of a method for using projected water usage at a premises to control an exterior water consuming object, such as an exterior irrigation system.

FIG. 4 is a block diagram of an embodiment of a water management system that includes a soil sensor.

FIG. 5 is a flow diagram of an embodiment of a method for operating a water management system, such as that shown in FIG. 4, using soil data.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Typical water infrastructure supplying a premises 105 includes a municipal backflow preventer 101a and a municipal water meter 101b. The municipal water meter 101b is located outside the premises 105 at a municipal water line 103 to the premises 105. This location of the municipal water meter 101b at the municipal water line 103 to the premises 105 restricts the municipal water meter 101b to measuring only a total amount of water that is supplied to the premises 105. Thus, relying on the municipal water meter 101b alone can make it difficult to discern, and manage, specific subsets of water use at the premises 105. Accordingly, specific subsets of water use at the premises 105 that are inefficient (e.g., leaks) and/or more than intended can go undetected and, even if detected, total premises water use as measured by the municipal water meter 101b can be too general in nature to allow for readily addressing and managing any specific subset of water use at the premises 105 that is inefficient and/or more than intended.

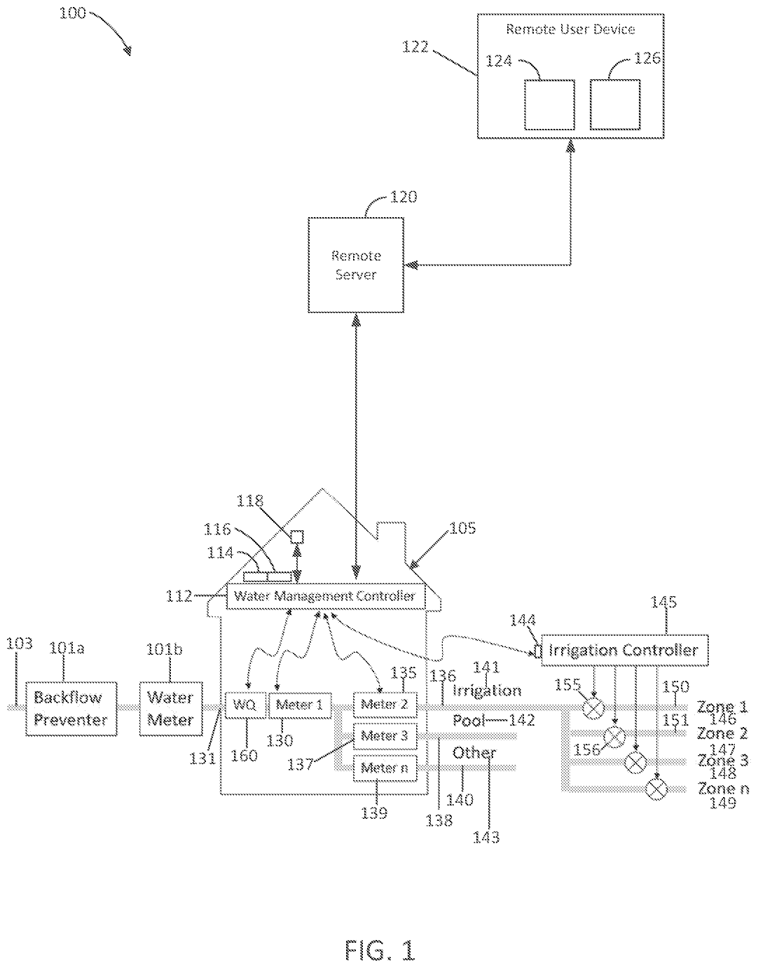

FIG. 1 illustrates a block diagram of an embodiment of a water management system 100 that can be useful for premises water usage management via specific insights as to one or more subsets of water use at the premises 105. As a result, the water management system 100 can allow a user to manage premises water use in a precise, tailored manner that efficiently addresses particular, targeted subsets of premises water use in a timely manner. As one example, the water management system 100 can allow a user to manage premises water use by inputting data as to premises water use targets (e.g., a premises water use target for a specific subset of water use at the premises 105) for a predetermined period and, in response, provide insights as to projected premises water use (e.g., over that predetermined period of time for which the target usage was set), including, for example, providing insights as to relatively high use and/or inefficient use areas for particular subsets of premises water use.

The water management system 100 shown at FIG. 1 includes a water management controller 112, a first water meter 130, and a second water meter 135. In the illustrated embodiment, the water management controller 112 is located at the premises 105, and the water management controller 112 can be in signal communication with one or more various components of the water management system 100 to receive data from such component(s) and output control signal(s) to such component(s).

The first water meter 130 can be positioned at a water ingress line 131 of the premises 105, with the water ingress line 131 being in fluid communication with the municipal water line 103 such that the water ingress line 131 receives water from the municipal water line 103 and supplies such water to the premises 105. The first water meter 130 can be configured to measure an amount of water supplied to the premises 105 via the water ingress line 131. The first water meter 130 can be in communication with the water management controller 112, for instance to send data to the water management controller 112. For instance, the first water meter 130 can be configured to send a measured amount of water supplied to the premises 105 over a preset time period to the water management controller 112. The first water meter 130 can be in wired or wireless communication with the water management controller 112.

The second water meter 135 can be positioned at a water egress line 136 of the premises 105, with the water egress line 136 being in fluid communication with the water ingress line 131 of the premises 105 such that water egress line 136 receives water from the water ingress line 131 and supplies such water to a first water consuming object (e.g., consuming a first subset of the total premises water usage) 141 associated with the premises 105. In some examples, the first water consuming object 141 can be an exterior water consuming object that outputs water at an exterior area of the premises 105. For instance, as one specific example, the first water consuming object 141 can be an exterior irrigation system, as shown in the example of FIG. 1. The second water meter 135 can be configured to measure an amount of water supplied from the premises 105 to the first water consuming object 141 associated with the premises 105 via the water egress line 136. The second water meter 135 can be in communication with the water management controller 112, for instance to send data to the water management controller 112. For instance, the second water meter 135 can be configured to send, to the water management controller 112, a measured amount of water supplied to the first water consuming object 141 associated with the premises 105 over a preset time period. The second water meter 135 can be in wired or wireless communication with the water management controller 112.

In further embodiments, the premises 105 can have multiple water egress lines, and the water management system 100 can include an additional water meter at one or more of the additional water egress lines of the premises 105. For example, in the embodiment illustrated at FIG. 1, the premises 105 can include three water egress lines—first water egress line 136, a second water egress line 138, and a third water egress line 140. As noted, the second water meter 135 can be positioned at the first water egress line 136 of the premises 105.

A third water meter 137 can be positioned at the second water egress line 138 of the premises 105, with the second water egress line 138 being in fluid communication with the water ingress line 131 of the premises 105 such that second water egress line 138 receives water from the water ingress line 131 and supplies such water to a second water consuming object (e.g., consuming a second subset of the total premises water usage) 142 associated with the premises 105. In some examples, the second water consuming object 142 can be an exterior water consuming object that outputs water at an exterior area of the premises 105. For instance, the second water consuming object 142 can be a different exterior water consuming object than the first water consuming object 141. As one specific example, the second water consuming object 142 can be a swimming pool, as shown in the example of FIG. 1. The third water meter 137 can be configured to measure an amount of water supplied from the premises 105 to the second water consuming object 142 associated with the premises 105 via the second water egress line 138. The third water meter 137 can be in communication with the water management controller 112, for instance to send data to the water management controller 112. For instance, the third water meter 137 can be configured to send, to the water management controller 112, a measured amount of water supplied to the second water consuming object 142 associated with the premises 105 over a preset time period. The third water meter 137 can be in wired or wireless communication with the water management controller 112.

And, a fourth water meter 139 can be positioned at the third water egress line 140 of the premises 105, with the third water egress line 140 being in fluid communication with the water ingress line 131 of the premises 105 such that third water egress line 140 receives water from the water ingress line 131 and supplies such water to a third water consuming object (e.g., consuming a third subset of the total premises water usage) 143 associated with the premises 105. In some examples, the third water consuming object 143 can be an exterior water consuming object that outputs water at an exterior area of the premises 105. For instance, the third water consuming object 143 can be a different exterior water consuming object than each of the first water consuming object 141 and the second water consuming object 142, with FIG. 1 designating such an example of the third water consuming object 143 as “other” to indicate that the third water consuming object 143 can be a different (e.g., different exterior) water consuming object than the first and second water consuming objects 141, 142. The fourth water meter 139 can be configured to measure an amount of water supplied from the premises 105 to the third water consuming object 143 associated with the premises 105 via the third water egress line 140. The fourth water meter 139 can be in communication with the water management controller 112, for instance to send data to the water management controller 112. For instance, the fourth water meter 139 can be configured to send, to the water management controller 112, a measured amount of water supplied to the third water consuming object 143 associated with the premises 105 over a preset time period. The fourth water meter 139 can be in wired or wireless communication with the water management controller 112. FIG. 1 shows the fourth water meter 139 as “Meter n” with “n” used to indicate any number of additional water meters and associated water egress lines for corresponding water consuming devices can be included in the system 100 beyond those shown in FIG. 1.

The water management controller 112 can be configured to receive data from one or more (e.g., all) of the water meters 130, 135, 137, 139 and/or from one or more (e.g., all) of the water consuming objects 141, 142, 143 and use this received data to facilitate water management at the premises 105.

As one example, the water management controller 112 can be configured to determine an amount of water used within (e.g., inside the walls defining an interior of) the premises 105 using at least (i) the measured amount of water supplied to the premises 105 via the water ingress line 131, and (ii) the measured amount of water supplied from the premises 105 to the first exterior water consuming object 141 via the first water egress line 136. In particular, in such a case, the water management controller 112 can be configured to determine an amount of water used within the premises 105 over a predetermined time period by determining a difference between (i) the measured amount of water supplied to the premises 105 via the water ingress line 131 over the predetermined time period, and (ii) the measured amount of water supplied from the premises 105 to the first exterior water consuming object 141 via the first water egress line 136 over the predetermined time period. Thus, the water management controller 112 can be configured to determine multiple subsets of water use associated with the premises 105—in this particular example one subset of overall water use associated with the premises 105 being interior premises water use and a second subset of overall water use associated with the premises 105 being exterior water consuming object 141 water use—by using the overall total amount of water supplied to the premises and the amount of water supplied to a specific water consuming object associated with the premises 105.

As a further example, the water management controller 112 can be further configured to determine the amount of water used within the premises 105 using at least (i) the measured amount of water supplied to the premises 105 via the water ingress line 131, (ii) the measured amount of water supplied from the premises 105 to the first exterior water consuming object 141 via the first water egress line 136, and (iii) the measured amount of water supplied from the premises 105 to the second exterior water consuming object 142 via the second water egress line 138. In particular, in such a case, the water management controller 112 can be configured to determine an amount of water used within the premises 105 over a predetermined time period by determining a difference between (i) the measured amount of water supplied to the premises 105 via the water ingress line 131 over the predetermined time period, and (ii) both the measured amount of water supplied from the premises 105 to the first exterior water consuming object 141 via the first water egress line 136 over the predetermined time period and the measured amount of water supplied from the premises 105 to the second exterior water consuming object 142 via the second water egress line 138 over the predetermined time period. Thus, the water management controller 112 can be configured to determine multiple subsets of water use associated with the premises 105—in this particular example one subset of overall water use associated with the premises 105 being interior premises water use, a second subset of overall water use associated with the premises 105 being first exterior water consuming object 141 water use, and a third subset of overall water use associated with the premises 105 being second exterior water consuming object 142—by using the overall total amount of water supplied to the premises and the amount of water supplied to specific water consuming objects 141, 142 associated with the premises 105.

In the embodiment of the water management system 100 shown at FIG. 1, as noted, the first exterior water consuming object 141 can be an exterior irrigation system. The exterior irrigation system can include an irrigation controller 145 and one or more irrigation zones, such as a first irrigation zone 146 and a second irrigation zone 147. The irrigation controller 145 can be in communication with the water management controller 112 such that data can be sent from the irrigation controller 145 to the water management controller 112 and data and/or control signals can be sent from the water management controller 112 to the irrigation controller 145. In some such embodiments, in addition to the first and second irrigation zones 146, 147, the exterior irrigation system can include additional irrigation zones as well, such as a third irrigation zone 148, and a “n” irrigation zone 149, where “n” is used to indicate any number of additional irrigation zones beyond the first, second, and third irrigation zones 146, 147, 148. The third and “n” irrigation zones 148, 149 can be similar to, or the same as, that described herein for the first and second irrigation zones 146, 147.

The first irrigation zone 146 can include a first irrigation zone water supply line 150 and a first irrigation zone valve 155. The first irrigation zone water supply line 150 can be connected to the first water egress line 136 associated with the premises 105 such that the first irrigation zone water supply line 150 receives water from the first water egress line 136 associated with the premises 105. The first irrigation zone valve 155 can be connected to the first irrigation zone water supply line 150, and the first irrigation zone valve 155 can be in communication with the irrigation controller 145. The first irrigation zone valve 155 can be actuated, for instance by the irrigation controller 145 and/or water management controller 112, between an open position that permits water flow from the first water egress line 136, through the first irrigation zone valve 155, and to one or more water output devices (e.g., one or more sprinklers) at the first irrigation zone water supply line 150 and a closed position that blocks water flow from the first water egress line 136 to the one or more water output devices at the first irrigation zone water supply line 150.

The second irrigation zone can include a second irrigation zone water supply line 151 and a second irrigation zone valve 156. The second irrigation zone water supply line 151 can be connected to the first water egress line 136 associated with the premises 105 such that the second irrigation zone water supply line 151 receives water from the first water egress line 136 associated with the premises 105. The second irrigation zone 156 valve can be connected to the second irrigation zone water supply line 151, and the second irrigation zone valve 156 can be in communication with the irrigation controller 145. The second irrigation zone valve 156 can be actuated, for instance by the irrigation controller 145 and/or water management controller 112, between an open position that permits water flow from the first water egress line 136, through the second irrigation zone valve 156, and to one or more water output devices (e.g., one or more sprinklers) at the second irrigation zone water supply line 151 and a closed position that blocks water flow from the first water egress line 136 to the one or more water output devices at the second irrigation zone water supply line 151.

Also in the illustrated embodiment of FIG. 1, where the first exterior water consuming object 141 is the exterior irrigation system, the exterior irrigation system can further include the second water meter 135. The irrigation controller 145 can be configured to execute a first irrigation zone irrigation cycle by actuating the first irrigation zone valve 155 to cause water to be supplied from the first water egress line 136 associated with the premises 105 and this water output via one or more water output devices (e.g., sprinklers) at the first irrigation zone water supply line 150. Likewise, the irrigation controller 145 can be configured to execute a second irrigation zone irrigation cycle by actuating the second irrigation zone valve 156 to cause water to be supplied from the first water egress line 136 associated with the premises 105 and this water output via one or more water output devices (e.g., sprinklers) at the second irrigation zone water supply line 151. In examples where the exterior irrigation system includes additional irrigation zones, such as the third and “n” irrigation zones 148, 149, the irrigation controller 145 can be configured to execute irrigation zone irrigation cycles at these additional irrigation zones by similarly actuating respective irrigation zones valves at these additional irrigation zones.

The water management controller 112 can be configured to determine an amount of water used by the executed irrigation cycles. In particular, in certain examples, the water management controller 112 can be configured to determine an amount of water used by each executed irrigation cycle, and thus determine an amount of water used by each irrigation zone 146, 147, 148, 149. For example, the water management controller 112 can be configured to determine an amount of water used by the first irrigation zone irrigation cycle using at least the measured amount of water supplied from the premises 105 to the exterior irrigation system via the first water egress line 136 during the first irrigation zone irrigation cycle. And, likewise, the water management controller 112 can be configured to determine an amount of water used by the second irrigation zone irrigation cycle using at least the measured amount of water supplied from the premises 105 to the exterior irrigation system via the first water egress line 136 during the second irrigation zone irrigation cycle. For instance, the second water meter 135 can send to the water management controller 112 the measured amount of water supplied from the premises 105 to the exterior irrigation system via the first water egress line 136 during the respective irrigation zone irrigation cycle.

This configuration of the water management controller 112 to determine an amount of water used by irrigation cycles executed at particular irrigation zones can be useful in precisely targeting water management insights and control actions. As one such example, this can allow the water management controller 112 to identify the presence of an irrigation system water leak at a particular irrigation zone of the irrigation system. To do so, for instance, at least one of the irrigation controller 145 and the water management controller 112 can be configured to execute calibrations at each respective irrigation zone to establish a water usage baseline for each respective irrigation zone and then compare this baseline to future water use determined during future executed irrigation cycles at each respective irrigation zone.

Namely, at least one of the irrigation controller 145 and the water management controller 112 can be configured to execute a first irrigation zone calibration, at the first irrigation zone 146, by actuating the first irrigation zone valve 155 to cause water to be supplied from the first water egress line 136 of the premises 105 and output this water via one or more water output devices at the first irrigation zone water supply line 150 for a first calibration period of time. Then, the at least one of the irrigation controller 145 and the water management controller 112 can be configured to determine an amount of water used by the first irrigation zone calibration using at least the measured amount of water supplied from the premises 105 to the exterior irrigation system via the first water egress line 136 during the first calibration period of time. Then, furthermore, the at least one of the irrigation controller 145 and the water management controller 112 can be further configured to compare the determined amount of water used by the first irrigation zone calibration during the first calibration period of time to the determined amount of water used by the first irrigation zone irrigation cycle during the first irrigation zone irrigation cycle. When the at least one of the irrigation controller 145 and the water management controller 112 determines that the determined amount of water used by the first irrigation zone calibration during the first calibration period of time differs from the determined amount of water used by the first irrigation zone irrigation cycle during the first irrigation zone irrigation cycle by a predetermined threshold (e.g., differs by more than 5%, differs by more than 10%, differs by more than 15%, differs by more than 20%, differs by more than 25%, etc.), the at least one of the irrigation controller 145 and the water management controller 112 can be configured to generate an irrigation system water leak alert. In the example described here, the generated irrigation system water leak alert can specify the particular irrigation zone (e.g., the first irrigation zone) where the leak has been determined to be present.

Likewise, at least one of the irrigation controller 145 and the water management controller 112 can be configured to execute a second irrigation zone calibration, at the second irrigation zone 147, by actuating the second irrigation zone valve 156 to cause water to be supplied from the first water egress line 136 of the premises 105 and output this water via one or more water output devices at the second irrigation zone water supply line 151 for a second calibration period of time. Then, the at least one of the irrigation controller 145 and the water management controller 112 can be configured to determine an amount of water used by the second irrigation zone calibration using at least the measured amount of water supplied from the premises 105 to the exterior irrigation system via the first water egress line 136 during the second calibration period of time. Then, furthermore, the at least one of the irrigation controller 145 and the water management controller 112 can be further configured to compare the determined amount of water used by the second irrigation zone calibration during the second calibration period of time to the determined amount of water used by the second irrigation zone irrigation cycle during the second irrigation zone irrigation cycle. When the at least one of the irrigation controller 145 and the water management controller 112 determines that the determined amount of water used by the second irrigation zone calibration during the second calibration period of time differs from the determined amount of water used by the second irrigation zone irrigation cycle during the second irrigation zone irrigation cycle by a predetermined threshold, the at least one of the irrigation controller 145 and the water management controller 112 can be configured to generate an irrigation system water leak alert. In the example described here, the generated irrigation system water leak alert can specify the second irrigation zone as being where the leak has been determined to be present.

In these described embodiments where the first exterior water consuming object is an exterior irrigation system, the irrigation controller 145 can, in some cases, include a rain delay input 144. In some such embodiments, the water management system controller 112 can send one or more control signals to the rain delay input 144 of the irrigation controller 145. As one example, the water management system controller 112 can be configured to use the determined amount of water used within the premises 105 (e.g., the determined amount of water used within the premises 105 exceeds a predetermined interior premises water use threshold for a predetermined period of time) to cause a reduction in the amount of water supplied from the premises 105 to the exterior irrigation system, and the water management controller 112 can be configured to transmit a water use reduction command to the rain delay input 144 of the irrigation controller 145. This can be useful in facilitating compatibility between the water management system controller 112 and the irrigation controller 145 (e.g., facilitating compatibility for receiving one or more control signals output, such as water use reduction control signals output, from the water management system controller 112 at the irrigation controller 145).

An additional embodiment of the water management system 100 can also include a water quality sensor 160, as shown, for example, at FIG. 1. The water quality sensor 160, when included in the system 100, can be located at the water ingress line 131 of the premises 105, for instance, so as to monitor the water supplied to the premises 105 via the municipal water line 103. The water quality sensor 160 can be in communication with the water management controller 112, and the water quality sensor 160 can be configured to measure at least one water quality metric of water supplied to the premises 105 via the water ingress line 131. Examples of types of water quality metrics can include water temperature, conductivity, hardness, turbidity, pH, and color.

As one such example, the water quality sensor 160 can be configured to measure a first type of water quality metric of water supplied to the premises 105 via the water ingress line 131 at a first time and communicate the first type of water quality metric measured at the first time to the water management controller 112. And, similarly, the water quality sensor 160 can be configured to measure the first type of water quality metric of water supplied to the premises 105 via the water ingress line 131 at a second time that is different than the first time and communicate the first type of water quality metric measured at the second time to the water management controller 112. The water management controller 112 can be configured to compare the first type of water quality metric measured at the first time to the first type of water quality metric measured at the second time. And, the water management controller 112 can be further configured to generate a water quality change alert when the first type of water quality metric measured at the first time differs from the first type of water quality metric measured at the second time by a predetermined threshold (e.g., differs by more than 5%, differs by more than 10%, differs by more than 15%, differs by more than 20%, differs by more than 25%, etc.). As such, the use of the water quality sensor 160 along with the water management controller 112 can allow notifications to be provided when one or more water quality metrics have changed.

In addition to the features and functions of the water management controller 112 described previously herein, the water management controller 112 can, in some embodiments, estimate future water usage associated with the premises 105. As one such example, the water management controller 112 can be configured to estimate an amount of water to be used within the premises 105 over a future preset period of time using at least the determined amount of water used within the premises 105 over a preceding period of time. And, the water management controller 112 can be configured to generate a premises projected water overuse alert when the estimated amount of water to be used within the premises 105 over the future preset period of time exceeds a preset premises target water usage amount for the future preset period of time. For instance, a user can input, to the water management controller 112, the preset premises target water usage amount and the future preset period of time, and the water and the water management controller 112 can compare the input preset premises target water usage amount to the estimated amount of water to be used within the premises 105 over the future preset period of time.

In some further embodiments, the water management controller 112 can be configured to cause one or more control actions to be taken based on the estimated amount of water to be used within the premises 105 over the future preset period of time. As one example, when the estimated amount of water to be used within the premises 105 over the future preset period of time exceeds a preset premises target water usage amount for the future preset period of time, the water management controller 112 can be configured to cause a reduction in the amount of water supplied from the premises 105 to any one or more water consuming objects associated with the premises 105. As one particular example, when the estimated amount of water to be used within the premises 105 over the future preset period of time exceeds a preset premises target water usage amount for the future preset period of time, the water management controller 112 can be configured to cause a reduction in the amount of water supplied from the premises 105 to the first exterior water consuming object 141 via the first water egress line 136. To facilitate this control functionality, a valve can be included at the first water egress line 136 and this valve can be in communication with the water management controller 112 such that the water management controller 112 can cause this valve to actuate between open and closed positions so as to adjust the amount of water supplied from the premises 105 to the first exterior water consuming object 141 via the first water egress line 136. In the example where the first exterior water consuming object 141 is an exterior irrigation system, and the water management controller 112 can be configured to cause the reduction in the amount of water supplied from the premises 105 to the exterior irrigation system by causing a scheduled irrigation cycle of the exterior irrigation system to be skipped. Similarly, a valve can be included at the water egress line 138 and/or the water egress line 140 and this valve can be in communication with the water management controller 112 such that the water management controller 112 can cause this valve to actuate between open and closed positions so as to adjust the amount of water supplied from the premises 105 to the respective exterior water consuming object in fluid communication with the water egress line 138 and/or the water egress line 140.

To execute one or more (e.g., all) of the functions and features described elsewhere herein, the water management controller 112 can include a non-transitory computer-readable storage article 114 that includes computer-executable instructions stored thereat, and the water management controller 112 can include programmable processing circuitry 116, such as one or more programmable processors, configured to execute the computer-executable instructions stored at the non-transitory computer-readable storage article 114. As such, the computer-executable instructions stored at the non-transitory computer-readable storage article 114 can include computer-executable instructions that, when executed by the programmable processing circuitry 116 cause the programmable processing circuitry 116 to perform one or more (e.g., all) of the functions and features described elsewhere herein with respect to the water management controller 112.

For instance, the programmable processing circuitry 116 can be configured to execute the computer-executable instructions, stored at the non-transitory computer-readable storage article 114, to cause the programmable processing circuitry 116 to receive, from the first water meter 130 positioned at the water ingress line 131 of a premises 105, a measured amount of water supplied to the premises 105 via the water ingress line 131. The programmable processing circuitry 116 can also be configured to execute the computer-executable instructions to cause the programmable processing circuitry 116 to receive, from the second water meter 135 positioned at the first water egress line 136 associated with the premises 105, a measured amount of water supplied from the premises 105 to the first exterior water consuming object 141 via the first water egress line 136. And, the programmable processing circuitry 116 can further be configured to execute the computer-executable instructions to cause the programmable processing circuitry 116 to determine an amount of water used within the premises 105 using at least (i) the measured amount of water supplied to the premises 105 via the water ingress line 131, and (ii) the measured amount of water supplied from the premises 105 to the first exterior water consuming object 141 via the first water egress line 136.

In a further instance, the computer-executable instructions can additionally be configured to cause the programmable processing circuitry to estimate an amount of water to be used within the premises 105 over a future preset period of time using at least the determined amount of water used within the premises 105 over a preceding period of time. And, the computer-executable instructions can additionally be configured to cause the programmable processing circuitry to, when the estimated amount of water to be used within the premises 105 over the future preset period of time exceeds a preset premises target water usage amount for the future preset period of time, cause a reduction in the amount of water supplied from the premises 105 to the first exterior water consuming object 141.

The water management system 100 can be configured to communicate with one or more remote devices to allow for sending data to and/or receiving data from such one or more remote devices and/or to allow for receiving one or more inputs (e.g., control commands, target water usage amounts for a future preset period of time, etc.) from such one or more remote devices for the system 100.

As shown in the embodiment of FIG. 1, the system 100 can include remote devices such as a remote server 120 and a remote user device 122. The remote server 120 and the remote user device 122 can each be in communication with the water management controller 112. For example, in the illustrated example, the remote server 120 is in communication with the water management controller 112, and the remote user device 122 is in communication with the water management controller 112 via the remote server 120. As such, the remote server 120 can send data to and/or receive data from the water management controller 112 and the remote server 120 can send one or more inputs, such as control commands for components in communication with the water management controller 112 and/or target water usage amounts for a future preset period of time, to the water management controller 112 and the water management controller 112 can cause corresponding actions to be executed at the relevant component(s) in communication with the water management controller 112. Likewise, the remote user device 122 can send data to and/or receive data from the water management controller 112 and the remote user device 122 can send one or more inputs, such as control commands for components in communication with the water management controller 112 and/or target water usage amounts for a future preset period of time, to the water management controller 112 and the water management controller 112 can cause corresponding actions to be executed at the relevant component(s) in communication with the water management controller 112.

The remote server 120 can include programmable processing circuitry and a non-transitory computer-readable storage article storing computer-executable instructions that, when executed by the programmable processing circuitry, cause the programmable processing circuitry to communicate with the water management controller 112. In addition, the stored computer-executable instructions, when executed by the programmable processing circuitry, cause the programmable processing circuitry to process data received from the water management controller 112. This can include, for instance, generating one or more reports relating to water use, or projected future water use, at and/or associated with the premises 105 (e.g., projected future water use based on extrapolated past measured water use at and/or associated with the premises 105, projected deviation of future water use from a preset water use target at and/or associated with the premises 105, water usage visualization by water use area at and/or associated with the premises 105).

The remote user device 122 can include a second non-transitory computer-readable storage article 124 and programmable processing circuitry (e.g., one or more processors 126). The second non-transitory computer-readable storage article 124 can store computer-executable instructions that, when executed by the programmable processing circuitry, cause the programmable processing circuitry to communicate with the water management controller 112 (e.g., via the remote server 120). In addition, these stored computer-executable instructions at the remote user device 122, when executed by the programmable processing circuitry, cause the programmable processing circuitry at the remote user device 122 to process data received from the water management controller 112 and/or the remote server 120. This can include, for instance, receiving one or more reports as described previously with respect to the remote server 120. This can also include, for instance, receiving user control input at the remote user device 122 and sending this user control input to the water management controller 112 to cause the water management controller 112 to execute the corresponding control function (e.g., actuate a valve (e.g., to shut off a detected leak), adjust a water use schedule, adjust a water usage amount, etc.).

Various types of generated alerts have been described elsewhere herein. These alerts can be sent from the water management controller 112 to the remote server 120 and/or the remote user device 122. For example, the remote user device 122 can receive one or more of these alerts and display an indication of the alert at the remote user device 122. In a further example, the remote user device 122 can display the indication of the alert and prompt user input at the remote user device 122. Upon receipt, the remote user device 122 can send the user input received in response to the prompt to the remote server 120 and/or to the water management controller 112.

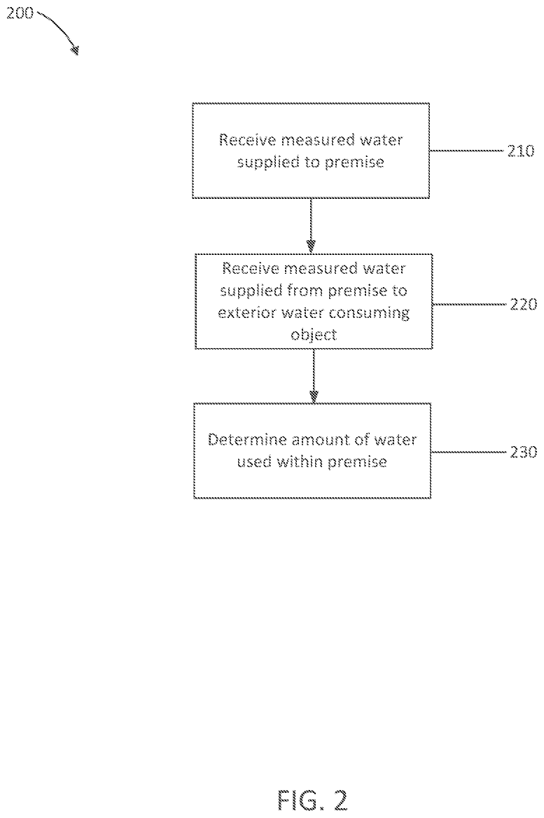

FIG. 2 is a flow diagram of an embodiment of a method 200 for determining water used within a premises. The method 200 can, in certain examples, be carried out at a water management system such as that similar to, or the same as, the water management system illustrated and described elsewhere herein.

At step 210, the method 200 includes receiving, at a water management controller, an amount of water, as measured by a first water meter positioned at a water ingress line of a premises, supplied to the premises via the water ingress.

At step 220, the method 200 includes receiving, at the water management controller, an amount of water, as measured by a second water meter positioned at a first water egress line of the premises, supplied from the premises to a first exterior water consuming object via the first water egress line.

At step 230, the method 200 includes determining an amount of water used within the premises using at least (i) the amount of water supplied to the premises via the water ingress line, and (ii) the amount of water supplied from the premises to the first exterior water consuming object via the first water egress line.

In a further embodiment, the method 200 can additionally include estimating, at the water management controller, an amount of water to be used within the premises over a future preset period of time using at least the determined amount of water used within the premises over a preceding period of time. And, when the estimated amount of water to be used within the premises over the future preset period of time exceeds a preset premises target water usage amount for the future preset period of time, causing, via the water management controller, a reduction in the amount of water supplied from the premises to the first exterior water consuming object.

In a further embodiment, the presence of a leak can be determined. For example, the presence of a leak can be determined when a water meter of the water management system fails to measure a no flow condition for a predetermined period of time, the water management system can determine that a leak is present. As one such example for the water management system embodiment shown at FIG. 1, if the second water meter fails to measure a no flow condition for a predetermined period of time the water management system (e.g., via the water management controller) can determine that a leak is present downstream of the second water meter (e.g., at the first water consuming object 141), if the third water meter fails to measure a no flow condition for a predetermined period of time the water management system (e.g., via the water management controller) can determine that a leak is present downstream of the third water meter (e.g., at the second water consuming object 142), and if the fourth water meter fails to measure a no flow condition for a predetermined period of time the water management system (e.g., via the water management controller) can determine that a leak is present downstream of the fourth water meter (e.g., at the third water consuming object 143). In some cases, the first water meter, the second water meter, and/or the third water meter can be associated with a water supply shut off valve. When the water management controller determines that a leak is present downstream of the second water meter the water management controller can send a control signal to cause the water supply shut off valve associated with the second water meter to close and terminate supply of water to the first water consuming object. When the water management controller determines that a leak is present downstream of the third water meter the water management controller can send a control signal to cause the water supply shut off valve associated with the third water meter to close and terminate supply of water to the second water consuming object. And, when the water management controller determines that a leak is present downstream of the fourth water meter the water management controller can send a control signal to cause the water supply shut off valve associated with the fourth water meter to close and terminate supply of water to the third water consuming object. Also, in some cases, when the water management controller determines that a leak is present, the water management controller can generate a leak alert and send the alert to the remote server and/or the remote user device. In one specific such case, when such a leak alert has been generated and no action has been taken to stop the leak for a predetermined period of time after the leak alert has been generated, the water management controller can send a control signal to cause the water supply shut off valve associated with the water meter corresponding to the detected leak to close and terminate supply of water to the leaking water consuming object.

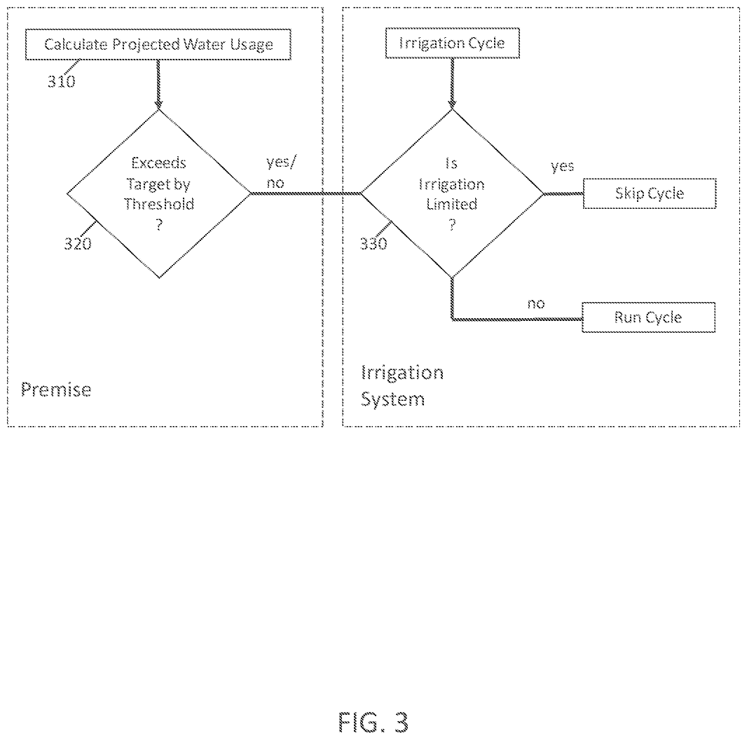

FIG. 3 is a flow diagram of an embodiment of a method 300 for using projected water usage at a premises to control an exterior water consuming object, such as an exterior irrigation system. The method 300 can, in certain examples, be carried out at a water management system such as that similar to, or the same as, the water management system illustrated and described elsewhere herein. While the example illustration of the flow diagram at FIG. 3 references an exterior irrigation system as a type of exterior water consuming object, the method 300 can similarly be carried out in association with various other types of water consuming objects typically found at a premises.

At step 310, the method 300 includes calculating projected future water usage at and/or associated with the premises. Projected future water usage can be calculated, for example, based on extrapolated past measured water use at and/or associated with the premises. In particular, in one example, past measured water use at the premises can be calculated by determining a difference between an amount of water measured, via a water meter, at a water ingress line to the premises and a total amount of water measured, via one or more water meters, at one or more water egress lines from the premises, and then projected future water usage can be calculated based on an extrapolation of this calculated, past measured water use at the premises.

At step 320, the method 300 includes determining whether the calculated projected future water usage at and/or associated with the premises, from step 310, exceeds a target water usage threshold for the premises.

If at step 320 it is determined that the calculated projected future water usage at and/or associated with the premises exceeds the target water usage threshold for the premises, then, at step 330, the method 300 includes adjusting water use at the exterior irrigation system. As shown in the example of FIG. 3, adjusting water use at the exterior irrigation system can include skipping a next scheduled irrigation cycle.

If at step 330 it is determined that the calculated projected future water usage at and/or associated with the premises is at or below the target water usage threshold for the premises, then, at step 330, the method 300 includes maintaining water use at the exterior irrigation system as previously scheduled. As shown in the example of FIG. 3, maintaining previously scheduled water use at the exterior irrigation system can include running a next scheduled irrigation cycle.

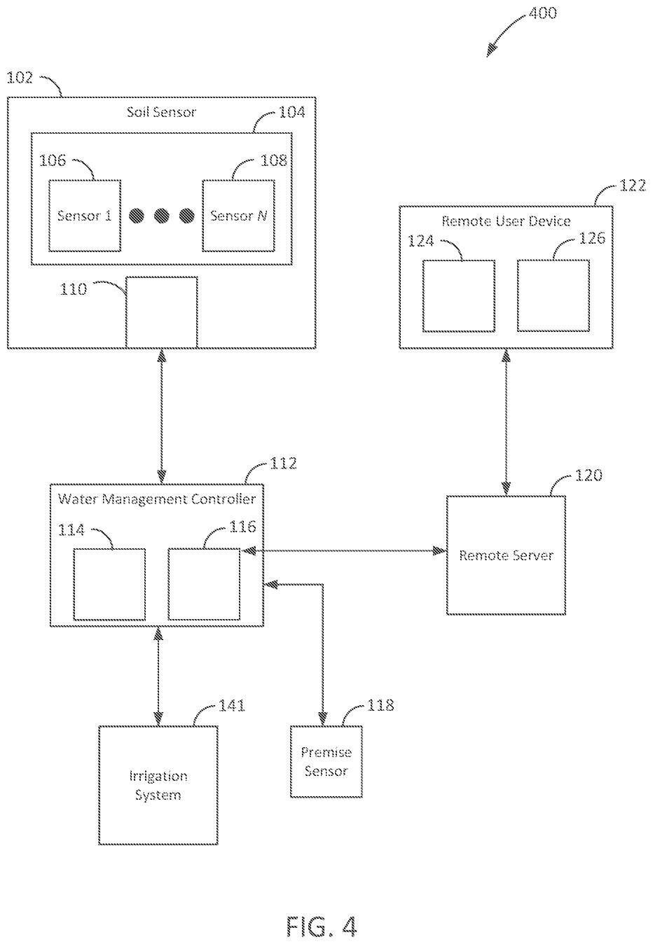

FIG. 4 shows a block diagram of an embodiment of a water management system 400 that includes a soil sensor 102. The water management system 400 can include one or more components and be configured to execute one or more functions as that illustrated and described previously herein with respect to the water management system 400. As such, the description that follows is directed, in part, to incorporation of the soil sensor 102 in the water management system 400.

As noted, in the illustrated embodiment, the system 400 includes the soil sensor 102. The soil sensor 102 includes a soil sensing component 104 with one or more sensors 106, 108. In the example shown here, the soil sensor 102 includes sensor 106 and sensor 108. Sensor 106 is shown a “sensor 1” and sensor 108 is shown as “sensor N” to illustrate that the soil sensing component 104 can include any number of sensors from one to N. The soil sensor 102 also includes a transmitter (e.g., a wireless transmitter) 110 which can be in signal communication with the water management controller 112. The water management controller 112 can include a non-transitory computer-readable storage article 114 and one or more processors 116. In the illustrated example, the water management controller 112 is in signal communication with a premises sensor 118 and a remote server 120. In the embodiment, the remote server 120 is further in signal communication with a remote user device 122. The remote user device 122 comprises a second non-transitory computer-readable storage article 124 and one or more processors 126. The water management controller 112 is also in signal communication with an irrigation system (e.g., sprinkler system) 141.

In some embodiments, the soil sensor 102, the water management controller 112, the premises sensor 118, and the sprinkler system 141 can each be located at a common premises. In such embodiments, however, the remote server 120 can be at a location remote from, and different than, the premises. The remote user device 122 can, for example, be carried with a user such that remote user device 122 can be at the premises when the user is present at the premises and away from the premises when the user is away from the premises. The remote user device 122 can be, for instance, a mobile computing device, such as a smart phone or tablet, that executes a locally stored application and/or receives data wirelessly over a communication network to communicate with the water management controller 112 via the remote server 120.

In FIG. 4, the soil sensing component 104 of the soil sensor 102 can detect various soil conditions and generate soil data representative of one or more soil conditions. The soil sensing component 104 can include one or more sensors which can measure specific soil properties. As shown in the embodiment of FIG. 4, and noted above, the soil sensing component 104 can include an n number of sensors 106, 108 which can measure specific soil properties. In some embodiments, the sensors 106, 108 can comprise a soil moisture sensor which can measure moisture content of the soil. In some embodiments, the sensors 106, 108 can comprise a soil pH sensor which can measure the acidity of the soil. In some embodiments, the sensors 106, 108 can include a temperature sensor which can measure the temperature of the soil and/or the temperature of the air (e.g. above the soil). In some embodiments, the sensors 106, 108 can include a sunlight sensor which can measure how much sunlight the soil receives. In some further embodiments, the sensors 106, 108 include a humidity sensor which can measure the moisture content of the soil and/or the moisture content of the air above the soil. Other types of sensors which can measure data relating to soil are contemplated. Additionally, in some embodiments, the sensors are combination sensors which measure more than one soil property such as moisture and pH. Further, in some embodiments, more than one of each type of soil sensor can be used. Thus, certain embodiments of the soil sensing component 104 can detect one or more (e.g., each) of the soil conditions referenced here.

Continuing with the embodiment of FIG. 4, the soil sensing component 104 generates soil data from the sensors 106, 108, and the wireless transmitter 110 can send this soil data from the soil sensing component 104 to the water management controller 112. The wireless transmitter 110 can send signals representative of soil to the water management controller 112 wirelessly using, for example, an antenna. The wireless transmitter 110 can operate via various wireless protocols which in some embodiments include Wi-Fi and/or Zigbee. However, in some embodiments, other wireless protocols are utilized. However, of note, in some embodiments, the wireless transmitter 110 can send signals to the water management controller 112 using wires in addition to or in lieu of wireless communication. Depending on the application, such as the specifics of the premises, wired communication may be desirable in some instances for speed of signal transmission and reliability. However, it can be advantageous to use wireless communication with the wireless transmitter 110 of the soil sensor 102 as the soil sensor 102 can be placed anywhere in a lawn or garden without routing wires to the soil sensor 102 and, thereby, creating cost and installation efficiencies. In the embodiment of FIG. 4, only one wireless transmitter 110 is used with the wireless transmitter 110 able to transmit data from each of the one or more sensors 106, 108 of the soil sensing component. In some embodiments, though, the soil sensor 102 includes more than one wireless transmitter. For example, one wireless transmitter can be used for each of the one or more sensors 106, 108 of the soil sensing component 104. In certain embodiments, the soil sensor 102 can include the wireless transmitter as part of a transceiver that allows the soil senor 102 to also receive one or more signals, for instance from the water management controller 112.

While the embodiment of FIG. 4 illustrates a single soil sensor 102, more than one soil sensor can be used. In such examples, each of the soil sensors can be in wireless communication with the control panel via a wireless transmitter. It can be advantageous to have multiple soil sensors as each soil sensor can measure a different area of a lawn or garden, for instance at a common premises.

Continuing with the embodiment of FIG. 4, the water management controller 112 includes the non-transitory computer-readable storage article 114 and the one or more processors 116. The one or more processors 116 are in communication with the non-transitory computer-readable storage article 114. In some embodiments, the non-transitory computer-readable storage article 114 is a memory such as flash memory, optical memory, magnetic memory, and read only memory (ROM). In some embodiments, the one or more processors 116 comprise integrated circuits (e.g. FPGA, ASIC, microprocessor). In some embodiments, the one or more processors are part of a computing device. The non-transitory computer-readable storage article 114 can be configured to comprise computer-executable instructions which can be executed by the one or more processors 116. For example, the non-transitory computer-readable storage article 114 can store a computer program which the one or more processors 116 of the water management controller 112 can execute. Executing the computer-executable instructions can cause the one or more processors 126 to perform various actions as is described elsewhere herein.

In some embodiments, the water management controller 112 is a premises control panel such as a home automation control panel and/or a security control panel. In some embodiments, the water management controller 112 is an existing control panel which is used for other operations such as home automation or security, with the soil sensor 102 input integrated into the existing control panel. For example, it can be advantageous to integrate communication with the soil sensor 102 into an existing control panel, as compared to adding a new control panel, as costs can be reduced. Additionally, as another example, using an existing control panel can reduce complexity and increase ease of use by using a single control panel instead of using multiple different control panels. The water management controller 112 can have many inputs and outputs such that it can be in signal communication with various aspects of the system.

The water management controller 112 of FIG. 4 is in signal communication with the soil sensor 102 and can receive signals from the soil sensor 102 via the wireless transmitter 110. Additionally, in some embodiments, the water management controller 112 can send signals to the soil sensor 102 through the wireless transmitter 110.

The water management controller 112 of FIG. 4 is also in signal communication with the premises sensor 118. The water management controller 112 can receive signals from the premises sensor 118 and, in some embodiments, can send signals to the premises sensor 118. The premises sensor 118 can generate one or more types of premises data. Premises data can include information about the premises at which, for example, the premises sensor 118 is installed. As one example, the premises sensor 118 can be a water usage sensor which can measure water volume usage at the premises over a period of time (e.g., over the past twenty four hours, over the past week, over the past month, etc.). In some embodiments, the premises sensor 118 is a flowmeter which can measure the water volume usage of the premises (e.g., house, apartment, commercial building, or other type of premises). In some such embodiments, the premises sensor 118 generates premises data which comprises data relating to the premises water volume usage. Premises data generated by the premises sensor 118 can be sent to the water management controller 112 which can use the premises data as described elsewhere herein.

While the premises sensor 118 can be a water usage sensor, other premises sensors can be included in the system 400. For example, in some embodiments, the premises sensor 118 is a water quality sensor which can measure various properties of the water supplied to the premises. In such embodiments, the premises sensor can send water quality data to the control panel which the control panel can use to perform, or not perform, various actions. In some embodiments, the premises sensor 118 is an occupancy sensor which can determine if the premises is occupied. For example, the occupancy sensor can determine that the premises has not been occupied for an amount of time and send a signal indicating as such to the water management controller 112. In some embodiments, the premises sensor 118 is a daylight sensor which can determine how an amount of light irradiance at the premises to determine whether the sun is shining at any point in time. For example, the daylight sensor can send a signal to the water management controller 112 indicating that it does not detect daylight, which can indicate the sun is not shining or that the weather is overcast. In some embodiments, the premises sensor 118 is a rain detector which can detect if it is raining. For example, the rain detector can determine that it is raining and send a corresponding signal to the water management controller 112 which indicates it is actively raining. In some such embodiments, the rain detector can send a signal indicating the rate of rainfall and/or the amount of rainfall to the control panel. In some examples, the premises sensor can be a security sensor which can send a signal to the control panel if the security sensor detects a security issue. In some examples, the premises sensor 118 can be a thermostat which can send a signal to the water management controller 112 with the temperature of the inside of the premises. In some examples, the premises sensor is an energy sensor which can determine an amount of electric and/or gas energy used by the premises. For example, the energy sensor can determine that the amount of electricity used exceeds a threshold and send a signal indicating as such to the water management controller 112. In some examples, the premises sensor 118 is a premises appliance sensor which can detect resource usage, such as energy and/or water usage, of an appliance at the premises. For example, the premises appliance sensor can determine that one or more appliances at the premises is consuming water (e.g., a dishwasher at the premises is using water to run a dishwashing cycle) and send a corresponding signal to the water management controller 112 which indicates that one or more appliances at the premise are consuming water. In some such embodiments, the premises appliance sensor can send a signal indicating the amount of water being consumed by the one or more appliances, and the water management controller 112 can take one or more actions, such as those described elsewhere herein (e.g., controlling, such as reducing or terminating, water usage, at other devices associated with the premises), based on the signal from the premises appliance sensor. The premises sensor 118 is not limited to the example sensors described and a person of ordinary skill will understand other types of premises sensors are contemplated. Further, in some embodiments, more than one premises sensor can be used and can be in signal communication with the water management controller 112.

Continuing with the embodiment of FIG. 4, the water management controller 112 is also in signal communication with the remote server 120. The remote server can be a computing device located remotely from the water management controller 112 and premises at which the water management controller 112 is present. In some embodiments, the remote server is internet connected and can send and receive data over the internet (e.g., with the water management controller 112 and/or user device 122 via a WiFi connection at the water management controller 112 and/or user device 122). The signal communication between the water management controller 112 and the remote server 120 can be a wired connection and/or a wireless connection. In operation, the remote server 120 can send and receive signals from the water management controller 112. The remote server 120 is also in signal communication with the remote user device 122 and can send and receive signals from the remote user device 122. The signal communication between the remote user device 122 and the remote server 120 can be wireless connection and/or a wired connection.

In some embodiments, the remote user device 122 is an internet capable device which can send and receive signals wirelessly to the remote server 120 (e.g., via a WiFi connection at the user device 122). In some embodiments, the remote user device can include a display which can display notifications. For example, in some embodiments, the remote user device 122 is a phone, tablet, or computer which can receive information from the remote server 120 and display notifications which are related to the information received from remote server 120.

The remote user device 122 includes the second non-transitory computer-readable storage article 124 and the one or more processors 126. The one or more processors 126 are in communication with the second non-transitory computer-readable storage article 124. In some embodiments, the second non-transitory computer-readable storage article 124 is a memory such as flash memory, optical memory, magnetic memory, and read only memory (ROM). In some embodiments, the one or more processors 126 comprise integrated circuits (e.g. FPGA, ASIC, microprocessor). In some embodiments, the one or more processors 126 are part of a computing device. The second non-transitory computer-readable storage article 124 can be configured to comprise computer-executable instructions which can be executed by the one or more processors 126. For example, the second non-transitory computer-readable storage article 124 can store a computer program which can be executed by the one or more processors 126 of the remote user device 122. Executing the computer-executable instructions can cause the one or more processors 126 to perform various actions as is described elsewhere herein.

Further, in the embodiment of FIG. 4, the water management controller 112 is in signal communication with the sprinkler system 141. The sprinkler system 141 can be a system which includes one or more sprinkler head that serve as outlets for a connected water source, and each of these water of more sprinkler heads can be connected to a water source that provides water to an area, such as a lawn or garden. In some embodiments, the sprinklers of the sprinkler system can be connected into zones comprising multiple sprinklers. In some such embodiments, specific zones can be actively watering an area while other sprinklers are inactive, for instance depending on the control signal output by the control water management controller 112 to the sprinkler system 141. In some embodiments, a user can change individual sprinklers from one zone to another and can change the number and/or size of the zones. In some embodiments, the sprinkler system 141 can include a controller for controlling the various aspects of the sprinkler system (e.g. sprinkler zones) and the controller can interface with the water management controller 112.

In an example operation of the embodiment of FIG. 4, the soil sensor 102 can be located in the soil of a lawn at the premises. The one or more sensors 106, 108 of the soil sensing component 104 of the soil sensor 102 can sense soil properties and generate soil data, such as the moisture content of the soil. The wireless transmitter 110 of the soil sensor 102 can send the soil data wirelessly to the water management controller 112. The water management controller 112, using the one or more processors 116 can analyze the soil data to determine whether the soil data satisfies a predetermined soil condition, such as a specific moisture content threshold. The premises sensor 118 can generate premises data, such as a volume of water used over a period of time, and the water management controller 112 can receive this premises data from the premises sensor 118. The water management controller 112, using the one or more processors 116, can analyze the premises data to determine whether the premises data satisfies a predetermined premises condition, such as a specific water usage threshold. When the soil data satisfies the predetermined soil condition, the water management controller 112 can generate an output signal relating to the predetermined soil condition using the one or more processors 116.

In some embodiments, the output signal can be a command signal for a sprinkler system. For example, the command signal for the sprinkler system can include a sprinkler on command and/or a sprinkler off command. In this example, the command signal can be sent to the sprinkler system 141 which can start or stop the sprinkler system when this command signal is received. In some embodiments, the sprinkler command signal selectively starts or stops one or more zones of the sprinkler system, such that the command signal can be zone specific thus causing the sprinkler system to independently take the corresponding action at the specified zone of the sprinkler system.

In some embodiments, the output signal can be a notification for the remote user device 122. In some such embodiments, the water management controller 112 sends the notification, which can include information relating to the predetermined soil condition, to the remote server 120. The remote user device 122 can connect to the remote server 120 and can receive, via the remote server 120, the notification including the information relating to the predetermined soil condition using the one or more processors 126. The remote user device 122 can display the notification on a display which can provide the information to a user. For example, the notification can include a pH level of the soil and the remote user device 122 can display the notification to the user so that the user can know the pH level of the soil. In another embodiment, the notification which includes information relating to the predetermined soil condition can comprise further information such as a message. For example, the remote user device 122 can receive a notification which includes information that a predetermined soil condition of low moisture content has been met. In such an example, the information can include a message indicating a need to water the soil (e.g. due to the low moisture content).

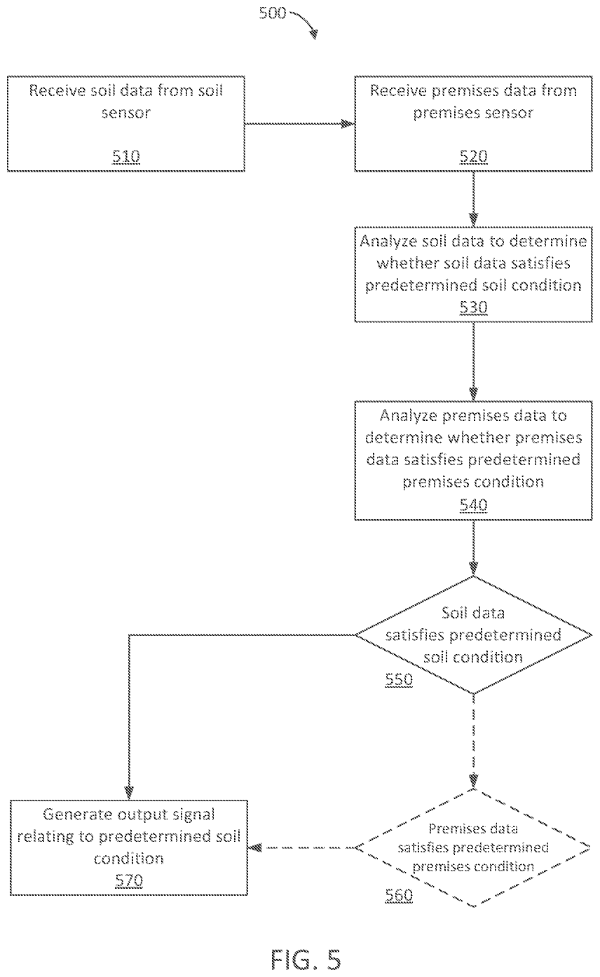

FIG. 5 is a flow diagram of an example method 500 of operation of the system of FIG. 4 according to an aspect of the present disclosure. In the flow diagram, the water management controller 112 can comprise a non-transitory computer-readable storage article 114 which comprises computer-executable instructions that, when executed by the one or more processors 116 of the water management controller 112, can perform the steps of 510 through 570. Starting at 510, the water management controller 112 can receive soil data from the soil sensor 102 which includes the soil sensing component 104. In some embodiments, the soil data received can include data relating to soil moisture content. In some embodiments, the soil data received can include data relating to soil pH, data relating to temperature, data relating to sunlight exposure, and/or data relating to humidity (e.g., in addition to, or as an alternative to, soil moisture content). In some embodiments, the soil data can include data relating to multiple sources such as soil moisture content and pH. In some embodiments, the water management controller 112 receives the soil data by way of the one or more processors 116.

At step 520, the water management controller 112 can receive premises data from the premises sensor 118. In some embodiments, the premises data can include data relating to premises water usage. In some embodiments, the premises data can include data relating to water quality, data related to temperature of the premises, data related to occupancy of a space, data related to energy usage, data relating to weather, and data related to security. In some embodiments, the premises data can include data relating to multiple sources such as water usage and energy usage. In some embodiments, the water management controller 112 receives the premises data by way of the one or more processors 116.

At step 530, the water management controller 112 can analyze the soil data to determine whether the soil data satisfies a predetermined soil condition. The water management controller 112 can use the one or more processors 116 alone or in combination with the non-transitory computer-readable storage article 114 to analyze the soil data. The predetermined soil condition can include a variety of soil conditions. For example, in some embodiments, the predetermined soil condition can comprise a predetermined soil moisture content threshold. Additionally or alternatively, in some embodiments, the predetermined soil condition can comprise a predetermined soil pH threshold, a predetermined temperature threshold, predetermined sunlight exposure threshold, and/or a predetermined humidity threshold. Thus, in some embodiments, the control panel can determine whether the soil data, which can include data relating to various soil properties (e.g. soil moisture content, soil pH), satisfies the predetermined soil condition, which can include various thresholds (e.g. soil moisture content threshold, soil pH threshold). For example, the water management controller 112 can receive soil data relating to soil moisture content and to the soil pH from the soil sensor 102 as in step 510. The control panel can further analyze the soil data to determine whether the soil data exceeds the predetermined soil moisture content threshold and whether the soil data exceeds the predetermined soil pH threshold as in step 530.

In some embodiments, the various thresholds of the predetermined soil condition can be single values, however, in some examples, the thresholds are ranges of values. Further, in some embodiments, each threshold can be a combination of multiple thresholds that create different threshold levels for one or more types of soil data. For example, if the predetermined soil condition includes a predetermined soil moisture content threshold, the predetermined soil moisture content threshold can include more than one threshold level. In one such example, the soil moisture content threshold has three thresholds of 25%, 50%, and 75%. In this example, the soil moisture content can be between 0-24% before passing the first threshold, between 25-49% before passing the second threshold, and between 50-74% before passing the third threshold. Thus, the control panel can categorize the soil moisture content into specific ranges where it is below specific thresholds.

Additionally, in embodiments in which the predetermined soil condition comprises more than one predetermined threshold, the predetermined thresholds can be correlated to a different type of soil data and act to change the threshold values. For example, the predetermined soil condition can comprise a predetermined soil moisture content threshold and a predetermined sunlight exposure threshold. In such an example, the predetermined soil moisture content threshold can decrease if the predetermined sunlight exposure threshold is exceeded. Thus, the moisture of the soil can be below the predetermined moisture content threshold at one point but can exceed the predetermined moisture content threshold shortly thereafter if the predetermined sunlight exposure threshold is exceeded.

In some embodiments, the predetermined soil condition (e.g. soil moisture content) can be changed (e.g. by a user). In some such embodiments, the water management controller 112 changes the predetermined soil condition while in some examples, the remote server and/or remote user device changes the predetermined soil condition. It can be advantageous to dynamically adjust the predetermined soil condition, including the predetermined thresholds, as the soil properties can change significantly over time.

At step 540, the water management controller 112 can analyze the premises data to determine whether the premises data satisfies a predetermined premises condition. The water management controller 112 can use the one or more processors 116 alone or in combination with the non-transitory computer-readable storage article 114 to perform the analyzing of the premises data. The predetermined premises condition can include a variety of premises data. For example, in some embodiments, the predetermined premises condition can comprise a premises water volume usage threshold. Additionally or alternatively, in some embodiments, the predetermined premises condition can comprise a water quality threshold, an energy usage threshold, a movement threshold, an interior temperature threshold, a daylight threshold, a rain threshold, and/or other conditions and thresholds. Thus, in some embodiments, the control panel can determine whether the premises data, which can include data relating to various premises properties (e.g. premises water usage, premises energy usage), satisfies the predetermined soil condition, which can include various thresholds (e.g. water usage threshold, energy usage threshold). For example, the water management controller 112 can receive premises data relating to premises water usage and to the premises energy usage from the premises sensor 118 as in step 520. The control panel can further analyze the premises data to determine whether the premises data exceeds the predetermined water usage threshold and whether the premises data exceeds the energy usage threshold as in step 540.

In some embodiments, the various thresholds of the predetermined premises condition can be single values, however, in some examples, the thresholds are ranges of values. Further, in some embodiments, each threshold can be a combination of multiple thresholds (e.g., thresholds associated with different seasons of a year). For example, if the predetermined premises condition comprises a predetermined premises water volume usage threshold, the predetermined premises water volume usage threshold can comprise more than one threshold level. In one such example, the premises water usage has three thresholds of below average, average, and above average. In the example, the premises water usage can be below the below average, between the below average and average, between the average and above average, and be above the above average. Thus, the control panel can categorize the premises water usage into ranges where it is below specific thresholds.

Additionally, in embodiments in which the predetermined premises condition comprises more than one predetermined threshold, the predetermined thresholds can interact with each other and change the threshold values. For example, the predetermined premises condition can comprise a predetermined premises water volume usage threshold and an energy usage threshold. In such an example, the predetermined premises water volume usage threshold can decrease if the predetermined energy usage threshold is exceeded. Thus, the premises water usage can be below the predetermined premises water usage threshold at one point but can exceed the predetermined premises water usage shortly thereafter if the predetermined energy usage threshold is exceeded.

In some embodiments, the predetermined premises condition (e.g. premises water usage) can be changed (e.g. by a user). In some such embodiments, the water management controller 112 changes the predetermined premises condition while in some examples, the remote server and/or remote user device changes the predetermined premises condition. It can be advantageous to dynamically adjust the predetermined premises condition, including the predetermined thresholds, as the cost of water and/or energy usage can change over time.

Generally referring to steps 530 and 540, in some embodiments, the analysis of the premises data can affect and be affected by the analysis of the soil data. In some such embodiments, the predetermined soil condition and/or the predetermined premises condition can change. For example, if the water management controller 112 in step 530 determines from the soil data that the soil moisture content is a first moisture value (e.g., 25%), which may normally satisfy the predetermined soil condition, the water management controller 112 can lower the soil moisture content threshold (e.g., by a preset moisture threshold reduction value) to a second moisture value (e.g., 20%) that is lower than the first value based on analysis of premises data which indicates above average premises water usage. In another example, if the water management controller 112 in step 540 determines from the premises data that the premises water usage is below average, the water management controller 112 can raise the soil moisture content threshold (e.g., by a preset moisture threshold incremental value) from the first moisture value (e.g., 25%), which would not normally satisfy the predetermined soil condition, to a third moisture value (e.g., 30%) which satisfies the predetermined soil condition. Thus, the water management controller 112 can change the predetermined soil condition and/or the predetermined premises condition based on analysis of the soil data and/or the premises data. In certain embodiments, the soil moisture content threshold, or other soil data threshold, can be raised or lowered by a present threshold reduction/incremental value that is selected from a group consisting of two or more preset threshold reduction/incremental values with the present threshold reduction/incremental value be selected from this group as a function of the magnitude of another premises data point (e.g., water volume usage) or soil data point (e.g., sunlight exposure). In this way, the soil moisture content can be adjusted to a degree corresponding to the magnitude of one or more other premises data and/or soil data points.

At step 550, the water management controller 112 has analyzed the soil data and determined that the soil data satisfies the predetermined soil condition. For example, if the soil data relates to soil moisture content, the soil moisture content can be determined to be above the predetermined soil moisture content threshold (e.g. outside an acceptable range). As discussed elsewhere herein, in some embodiments, the predetermined soil condition can include multiple thresholds and is not limited to the soil moisture content threshold. In some such embodiments, at step 550, the soil data has satisfied the multiple thresholds. For example, in some embodiments, the soil data satisfies the predetermined soil condition when both the data relating to soil moisture content satisfies the predetermined soil moisture content threshold and at least one of the data relating to a different soil property satisfies its threshold. The at last one of the data relating to a different soil property satisfying its threshold can include: data relating to soil pH satisfying the predetermined soil pH threshold, data relating to temperature satisfies the predetermined temperature threshold, the data relating to sunlight exposure satisfies the predetermined sunlight exposure threshold, and/or the data relating to humidity satisfies the predetermined humidity threshold. In some embodiments, when the soil data satisfies the predetermined soil condition, the method of operation continues with step 560. In some embodiments, when the soil data satisfies the predetermined soil condition, the method of operation continues with step 570.

However, in some embodiments, the soil data does not satisfy the predetermined soil condition. In some such embodiments, the process can begin again from step 510, wherein the water management controller 112 receives soil data from the soil sensor 102. For example, if the soil data relates to soil moisture content, the soil moisture content can be determined to be below the soil moisture content threshold (e.g. inside an acceptable range) where watering is unnecessary. The water management controller 112 can then receive new data from the soil sensor 102 and repeat the process of analyzing and determining whether the soil data satisfies the predetermined soil condition.

At step 560, the water management controller 112 has analyzed the premises data and determined that the premises data satisfies the predetermined premises condition. For example, if the premises data relates to premises water usage, the premises water usage can be determined to be above the premises water usage threshold (e.g. outside an acceptable range). As discussed elsewhere herein, in some embodiments, the predetermined premises condition can include multiple thresholds and is not limited to the premises water usage threshold. In some such embodiments, at step 560, the premises data has satisfied the multiple thresholds. In some embodiments, when the premises data satisfies the predetermined premises condition, the method of operation continues with step 570.

However, in some embodiments, the premises data does not satisfy the predetermined premises condition. In some such embodiments, the process can begin again from step 510, wherein the water management controller 112 receives soil data from the soil sensor 102. For example, if the premises data relates to premises water usage, the premises water usage can be determined to be below the premises water usage threshold (e.g. inside an acceptable range). The water management controller 112 can then receive new data from the soil sensor 102 and premises data from the premises sensor 118 and repeat the process of analyzing and determining whether the soil data satisfies the predetermined soil condition and whether the premises data satisfies the predetermined premises condition.

Moving to step 570, at step 570, the water management controller 112 can generate an output signal relating to the predetermined soil condition. In some embodiments, the water management controller 112 generates the output signal relating to the predetermined soil condition by way of the one or more processors 116. In some embodiments, the output signal generated can be output to a sprinkler system 141 in the form of a sprinkler system command signal which comprises at least one of a sprinkler system on command and a sprinkler system off command. In some embodiments, the output signal generated can be output to a remote user device 122 in the form of a notification which includes information relating to the predetermined soil condition. In some embodiments, the remote user device 122 comprises a second non-transitory computer-readable storage article 124 comprising second computer-executable instructions and one or more processors 126. In some embodiments, the output signal generated can be output to a remote server which can receive the output signal before it is output to the remote user device 122. In some such embodiments, the one or more processors 126 of the remote user device 122 can receive information relating to the predetermined soil condition from the remote server 120 and can further display a notification relating to the predetermined soil condition at the remote user device 122. In some embodiments, the output signal can be output to multiple aspects of the system. For example, in some embodiments, the output signal can be output to the sprinkler system 141 in the form of a sprinkler system command signal and can also be output to the remote server 120 and/or the remote user device 122 (e.g. through the remote server 120).

Continuing with step 570, in some embodiments, the output signal can be overridden. For example, in some embodiments, when the soil data satisfies the predetermined soil condition, if the premises data also satisfies a predetermined premises condition as in step 560, the one or more processors of the water management controller 112 can override the output signal relating to the predetermined soil condition of step 570.

For example, in some embodiments the water management controller 112 receives soil data from the soil sensor 102 and receives premises data from the premises sensor as in steps 510 and 520. The water management controller 112 then analyzes the soil data to determine whether the soil data satisfies a predetermined soil condition and analyzes the premises data to determine whether the premises data satisfies a predetermined premises condition as in steps 530 and 540. In these embodiments, the soil data received from the soil sensor can be related to any soil condition. Additionally, the soil data received from the soil sensor satisfies the predetermined soil condition as in step 550 and the operation would continue with step 570. However, in these embodiments, the premises data received from the premises sensor comprises data relating to the premises water usage, and the predetermined premises condition comprises a predetermined premises water usage threshold. Furthermore, in these embodiments, the premises data relating to premises water usage exceeds the predetermined premises water usage threshold. Thus, the water management controller 112 can override the output signal relating to the predetermined soil condition (e.g. a sprinkler system on command). Because the predetermined premises water usage was exceeded as measured by the premises sensor, the sprinkler system is blocked from receiving the output signal (e.g. the sprinkler system on command).

While the steps of 510 through 570 are shown as being performed sequentially, in some embodiments, the steps are not performed sequentially. Further, in some embodiments, multiple steps can be performed substantially simultaneously. For example, the control panel can receive soil data from the soil sensor at the same time as it receives premises data from the premises sensor. In another example, the control panel analyzes the soil data after it analyzes the premises data. In yet another example, the control panel can receive soil data from the soil sensor at the same time as it analyzes soil data previously received from the soil sensor to determine whether it satisfies the predetermined soil condition. It can be advantageous for the control panel to perform one or more of the steps of FIG. 5 substantially simultaneously as the time to perform the overall operation can be reduced.

Referring generally to the example system of FIG. 4 and to the flow diagram of FIG. 5, the water management controller 112 can receive data from the soil sensor 102 and the premises sensor 118, and thereby aggregating the data into a single location. The water management controller 112 further analyzes the data and can generate, or override, an output signal based on the aggregated data. Advantages of the example system and process include that a sprinkler system can decrease its water usage. For example, the system can determine that the moisture content of the soil, along with other soil parameters, are not above/below a threshold where watering is necessary. In this way, the sprinkler system does not use as much water as it otherwise would, reducing wasted water and ensuring proper levels of moisture in the soil. Further advantages include that a user can easily monitor multiple soil conditions from a remote user device and can also be notified when the sprinkler system has been turned on due to the soil conditions. Additionally, as the thresholds of the predetermined soil condition and the predetermined premises condition can be changed, a user can configure the system to generate a sprinkler system on command and/or a notification that is specific to the user's desires. For example, if the premises water usage is relatively high, the soil moisture content is relatively low, and the system is overriding the sprinkler system on command, a user can configure the system such that the override signal is no longer generated (e.g. by raising the premises water usage threshold). Another advantage of the system is that in some embodiments, it can dynamically adjust the threshold of the predetermined soil condition and/or the threshold of the predetermined premises condition based on analysis of the soil data and/or the premises data. In this way, the system is optimized as it can adjust the system to changing conditions of the soil and/or premises. For example, the system can override a sprinkler system on command when premises water usage is above average.

In some examples, a non-transitory computer-readable storage article comprises computer-executable instructions that can be executed by one or more processors of a computing device. When executed, the computer-executable instructions can cause the one or more processors of the computing device to receive soil data from a soil sensor and receive premises data from a premises sensor. Additionally, executing the computer-executable instructions can cause the one or more processors to analyze the soil data to determine whether the soil data satisfies a predetermined condition and analyze the premises data to determine whether the premises data satisfies a predetermined premises condition. If and when the soil data satisfies the predetermined soil condition, the one or more processors of the computing device can generate an output signal relating to the predetermined soil condition. In some embodiments, the one or more processors of the computing device are the one or more processors 116 of the water management controller 112 and the computer-readable storage article comprising computer-executable instructions is the non-transitory computer-readable storage article 114 of the water management controller 112. Further, in some embodiments, executing the computer-executable instructions via the one or more processors causes the one or more processors to perform steps similar to those of 510 through 570 in the example of FIG. 5.

Various examples have been described. These and other examples are within the scope of the following claims.

What is claimed is:

1. A water management system comprising:
a water management controller at a premises:
a first water meter positioned at a water ingress line of the premises, the first water meter in communication with the water management controller, the first water meter configured to measure an amount of water supplied to the premises via the water ingress line; and
a second water meter positioned at a first water egress line of the premises, the second water meter in communication with the water management controller, the second water meter configured to measure an amount of water supplied from the premises to a first exterior water consuming object via the first water egress line,
wherein the water management controller is configured to determine an amount of water used within the premises using at least (i) the measured amount of water supplied to the premises via the water ingress line, and (ii) the measured amount of water supplied from the premises to the first exterior water consuming object via the first water egress line.

2. The system of claim 1, further comprising:
a third water meter positioned at a second water egress line of the premises, the third water meter in communication with the water management controller, the third water meter configured to measure an amount of water supplied from the premises to a second exterior water consuming object via the second water egress line,
wherein the water management controller is further configured to determine the amount of water used within the premises using at least (i) the measured amount of water supplied to the premises via the water ingress line, (ii) the measured amount of water supplied from the premises to the first exterior water consuming object via the first water egress line, and (iii) the measured amount of water supplied from the premises to the second exterior water consuming object via the second water egress line.

3. The system of claim 1, wherein the first exterior water consuming object is an exterior irrigation system.

4. The system of claim 3, wherein the exterior irrigation system comprises:
an irrigation controller in communication with the water management controller,
a first irrigation zone that includes a first irrigation zone water supply line that is connected to the first water egress line of the premises and a first irrigation zone valve that is connected to the first irrigation zone water supply line, wherein the first irrigation zone valve is in communication with the irrigation controller, and
a second irrigation zone that includes a second irrigation zone water supply line that is connected to the first water egress line of the premises and a second irrigation zone valve that is connected to the second irrigation zone water supply line, wherein the second irrigation zone valve is in communication with the irrigation controller.

5. The system of claim 4, wherein the exterior irrigation system further comprises the second water meter, wherein the irrigation controller is configured to execute a first irrigation zone irrigation cycle by actuating the first irrigation zone valve to cause water to be supplied from the first water egress line of the premises and output via one or more water output devices at the first irrigation zone water supply line, and wherein the irrigation controller is configured to execute a second irrigation zone irrigation cycle by actuating the second irrigation zone valve to cause water to be supplied from the first water egress line of the premises and output via one or more water output devices at the second irrigation zone water supply line.

6. The system of claim 5, wherein the water management controller is configured to determine an amount of water used by the first irrigation zone irrigation cycle using at least the measured amount of water supplied from the premises to the exterior irrigation system via the first water egress line during the first irrigation zone irrigation cycle, and wherein the water management controller is configured to determine an amount of water used by the second irrigation zone irrigation cycle using at least the measured amount of water supplied from the premises to the exterior irrigation system via the first water egress line during the second irrigation zone irrigation cycle.

7. The system of claim 6, wherein at least one of the irrigation controller and the water management controller is configured to execute a first irrigation zone calibration by actuating the first irrigation zone valve to cause water to be supplied from the first water egress line of the premises and output via one or more water output devices at the first irrigation zone water supply line for a first calibration period of time, and wherein at least one of the irrigation controller and the water management controller is configured to determine an amount of water used by the first irrigation zone calibration using at least the measured amount of water supplied from the premises to the exterior irrigation system via the first water egress line during the first calibration period of time.

8. The system of claim 7, wherein at least one of the irrigation controller and the water management controller is further configured to compare the determined amount of water used by the first irrigation zone calibration during the first calibration period of time to the determined amount of water used by the first irrigation zone irrigation cycle during the first irrigation zone irrigation cycle, and wherein, when at least one of the irrigation controller and the water management controller determines that the determined amount of water used by the first irrigation zone calibration during the first calibration period of time differs from the determined amount of water used by the first irrigation zone irrigation cycle during the first irrigation zone irrigation cycle by a predetermined threshold, at least one of the irrigation controller and the water management controller generates an irrigation system water leak alert.

9. The system of claim 4, wherein the irrigation controller includes a rain delay input, wherein the water management system controller is configured to use the determined amount of water used within the premises to cause a reduction in the amount of water supplied from the premises to the exterior irrigation system, and wherein the water management controller is configured to transmit a water use reduction command to the rain delay input of the irrigation controller.

10. The system of claim 1, further comprising:
a water quality sensor at the water ingress line of the premises, the water quality sensor in communication with the water management controller, the water quality sensor configured to measure at least one water quality metric of water supplied to the premises via the water ingress line.

11. The system of claim 10, wherein the water quality sensor is configured to measure a first type of water quality metric of water supplied to the premises via the water ingress line at a first time and communicate the first type of water quality metric measured at the first time to the water management controller, and wherein the water quality sensor is configured to measure the first type of water quality metric of water supplied to the premises via the water ingress line at a second time that is different than the first time and communicate the first type of water quality metric measured at the second time to the water management controller.

12. The system of claim 11, wherein the water management controller is configured to compare the first type of water quality metric measured at the first time to the first type of water quality metric measured at the second time, and wherein the water management controller is further configured to generate a water quality change alert when the first type of water quality metric measured at the first time differs from the first type of water quality metric measured at the second time by a predetermined threshold.

13. The system of claim 1, wherein the water management controller is configured to estimate an amount of water to be used within the premises over a future preset period of time using at least the determined amount of water used within the premises over a preceding period of time.

14. The system of claim 13, wherein the water management controller is configured to generate a premises projected water overuse alert when the estimated amount of water to be used within the premises over the future preset period of time exceeds a preset premises target water usage amount for the future preset period of time, and wherein, when the estimated amount of water to be used within the premises over the future preset period of time exceeds a preset premises target water usage amount for the future preset period of time, the water management controller is configured to cause a reduction in the amount of water supplied from the premises to the first exterior water consuming object via the first water egress line.

15. The system of claim 14, wherein the first exterior water consuming object is an exterior irrigation system, and wherein the water management controller is configured to cause the reduction in the amount of water supplied from the premises to the exterior irrigation system by causing an irrigation cycle of the exterior irrigation system to be skipped.

16. The system of claim 1, further comprising:
an exterior premises sensor in communication with the water management controller: and
an interior premises sensor in communication with the water management controller,
wherein the water management controller is configured to use both exterior premises data from the exterior premises sensor and interior premises data from the interior premises sensor to control water usage of the first exterior water consuming object.

17. A water management controller comprising:
a non-transitory computer-readable storage article including computer-executable instructions; and
programmable processing circuitry configured to execute the computer-executable instructions to cause the programmable processing circuitry to:
receive, from a first water meter positioned at a water ingress line of a premises, a measured amount of water supplied to the premises via the water ingress line,
receive, from a second water meter positioned at a first water egress line of the premises, a measured amount of water supplied from the premises to a first exterior water consuming object via the first water egress line, and
determine an amount of water used within the premises using at least (i) the measured amount of water supplied to the premises via the water ingress line, and (ii) the measured amount of water supplied from the premises to the first exterior water consuming object via the first water egress line.

18. The water management controller of claim 17, wherein the computer-executable instructions are further configured to cause the programmable processing circuitry to:
estimate an amount of water to be used within the premises over a future preset period of time using at least the determined amount of water used within the premises over a preceding period of time, and
when the estimated amount of water to be used within the premises over the future preset period of time exceeds a preset premises target water usage amount for the future preset period of time, cause a reduction in the amount of water supplied from the premises to the first exterior water consuming object.

19. A method comprising the steps of:
receiving, at a water management controller, an amount of water, as measured by a first water meter positioned at a water ingress line of a premises, supplied to the premises via the water ingress;
receiving, at the water management controller, an amount of water, as measured by a second water meter positioned at a first water egress line of the premises, supplied from the premises to a first exterior water consuming object via the first water egress line; and
determining an amount of water used within the premises using at least (i) the amount of water supplied to the premises via the water ingress line, and (ii) the amount of water supplied from the premises to the first exterior water consuming object via the first water egress line.

20. The method of claim 19, further comprising the steps of:
estimating, at the water management controller, an amount of water to be used within the premises over a future preset period of time using at least the determined amount of water used within the premises over a preceding period of time; and
when the estimated amount of water to be used within the premises over the future preset period of time exceeds a preset premises target water usage amount for the future preset period of time, causing, via the water management controller, a reduction in the amount of water supplied from the premises to the first exterior water consuming object.
